(19) United States
(12) Patent Application Publication
(10) Pub. No.: US 2019/0070621 A1
(43) Pub. Date: Mar. 7, 2019

(54) SPRAYER AND PRESSURE WASHER COMPRISING SPRAYER

(71) Applicant: Control Devices, LLC, Fenton, MO (US)

(72) Inventors: Steven Salmons, St. Louis, MO (US); William Lemay, Manchester, MO (US)

(73) Assignee: Control Devices LLC, Fenton, MO (US)

(21) Appl. No.: 15/694,337

(22) Filed: Sep. 1, 2017

(51) Int. Cl. B05B 7/32; B05B 1/30; B05B 9/01; B08B 3/02

(52) U.S. Cl. CPC B05B 7/32; B08B 3/026; B05B 9/01; B05B 1/30

(57) ABSTRACT

A pressure washer for dispensing either water or a water-chemical mixture includes an injector for injecting chemical into water flowing through a hose at a relatively high flow rate. A sprayer connected to the hose has a passage having one upstream, one middle, and first and second downstream portions. The first downstream portion is connected to a high pressure conduit and the second downstream portion is connected to a high flow conduit less resistance to fluid flow than the high pressure conduit. A valve between the upstream portion and the middle portion selectively allows fluid flow to the middle portion of the passage. Another valve between the middle portion and downstream portion selectively allows flow to the second downstream portion and high flow conduit. Otherwise the valve directs flow through only the first downstream portion and high pressure conduit, which limits flow rate so as not to activate the injector.

### FIELD

This disclosure pertains generally to a pressure washer and more specifically to a pressure washer that includes a wand with an integral chemical dispensing outlet nozzle.

### BACKGROUND

Pressure washer wands (i.e., sprayers) typically include a single flow passage that extends from a trigger-actuated control valve to an outlet fixture configured for selectively connecting any of a plurality of different dispensing nozzles to the flow passage. The nozzles define orifices of different sizes and shapes for dispensing high pressure liquid (typically water or a mixture of water with a secondary chemical such as a surfactant) from the flow passage in different flow patterns. Smaller orifices restrict flow through the nozzle and thus increase the pressure of the stream of dispensed liquid. In many cases, a pressure washer includes a chemical injection nozzle that has a larger flow orifice configured to dispense the liquid at a relatively high flow rate for reasons explained below. During use of the sprayer, the nozzles can be removed from the outlet fixture and replaced as needed to perform the desired spray operation.

Pressure washers can be capable of injecting a liquid chemical (e.g., a surfactant such as soap) into the water that is dispensed through the wand. For example, some pressure washers include a container for holding the liquid chemical that is fluidly coupled to the pressurized water in the pressure washer by a venturi valve at a location upstream of the wand. At high flow rates, the water passing through the valve creates a negative pressure at the downstream end of the valve that is operative to draw the liquid chemical from the container into the flowing water. Whereas chemical injection nozzles are configured to permit flow through the wand flow passage at a sufficiently high flow rate to inject the liquid chemical into the flowing water, other nozzles limit the flow rate (in order to increase pressure) so that the negative pressure at the downstream end of the venturi valve is too low to draw the liquid chemical into the flow stream.

### SUMMARY

In one aspect, a sprayer for dispensing liquid comprises a housing having a passage therethrough. Said passage has one upstream portion, one middle portion, and a plurality of downstream portions including a first downstream portion and a second downstream portion. A first conduit is connected to the first downstream portion. A second conduit is connected to the second downstream portion. Said second conduit has lower resistance to fluid flow than said first conduit. A first valve is mounted along the housing passage between the upstream portion and the middle portion. Said first valve is selectively moveable between a closed position, in which the first valve blocks fluid flow through the housing passage, and an open position, in which the first valve allows fluid flow through the housing passage from the upstream portion to the middle portion. A second valve is mounted along the housing passage downstream from the first valve and between the middle portion and the downstream portions. Said second valve is selectively moveable between a low flow position, in which the second valve allows fluid flow through the housing passage from the middle portion to the first downstream portion of the passage, and a high flow position, in which the second valve allows fluid flow through the housing passage from the middle portion to the second downstream portion of the passage.

In another aspect, a spray system for alternatively dispensing pressurized water and a mixture of pressurized water and surfactant comprises a hose having an inlet and an outlet. A pressurized water source is in fluid communication with the inlet of the hose. A venturi is mounted in fluid communication with the hose between the pressurized water source and the hose inlet. Said venturi has an entrance, an exit, and a narrow section between said entrance and said exit. A container has an interior adapted for holding liquid surfactant. Said container has a tube having a lower end positioned adjacent a bottom of the interior of the container and an upper end connected to the narrow section of the venturi so that surfactant in the interior is drawn upward through the tube to enter water passing through the venturi when a pressure differential across the venturi exceeds a predetermined value. A sprayer is connected to the hose outlet. The sprayer comprises a housing having a passage therethrough. Said passage has one upstream portion, one middle portion, and a plurality of downstream portions including a first downstream portion and a second downstream portion. A first conduit is fluidly connected to the first downstream portion. A second conduit is fluidly connected to the second downstream portion. Said second conduit has lower resistance to fluid flow than said first pressure conduit. A first valve is mounted along the housing passage between the upstream portion and the middle portion. Said first valve is selectively moveable between a closed position, in which the first valve blocks fluid flow through the housing passage, and an open position, in which the first valve allows fluid flow through the housing passage from the upstream portion to the middle portion. A second valve is mounted along the housing passage downstream from the first valve and between the middle portion and the downstream portions. Said second valve is selectively moveable between a low flow position, in which the second valve allows fluid flow through the housing passage from the middle portion to the first downstream portion of the passage, and a high flow position, in which the second valve allows fluid flow through the housing passage from the middle portion to the second downstream portion of the passage.

Other aspects will be apparent in view of the following description and claims.

### BRIEF DESCRIPTION OF THE DRAWINGS

The drawings described herein are for illustration purposes only and are not intended to limit the scope of the present disclosure in any way.

FIG. 1 is a schematic illustration of a pressure washer;

FIG. 2 is a fragmentary longitudinal section of a wand of the pressure washer;

FIG. 3 is a fragmentary longitudinal section similar to FIG. 2 of another wand;

FIG. 4 is a cross section of the wand of FIG. 3 taken along line 4-4 of FIG. 3; and

FIG. 5 is a fragmentary longitudinal section similar to FIG. 2 of yet another wand.

Corresponding reference characters indicate corresponding parts throughout the drawings.

### DETAILED DESCRIPTION OF THE DRAWINGS

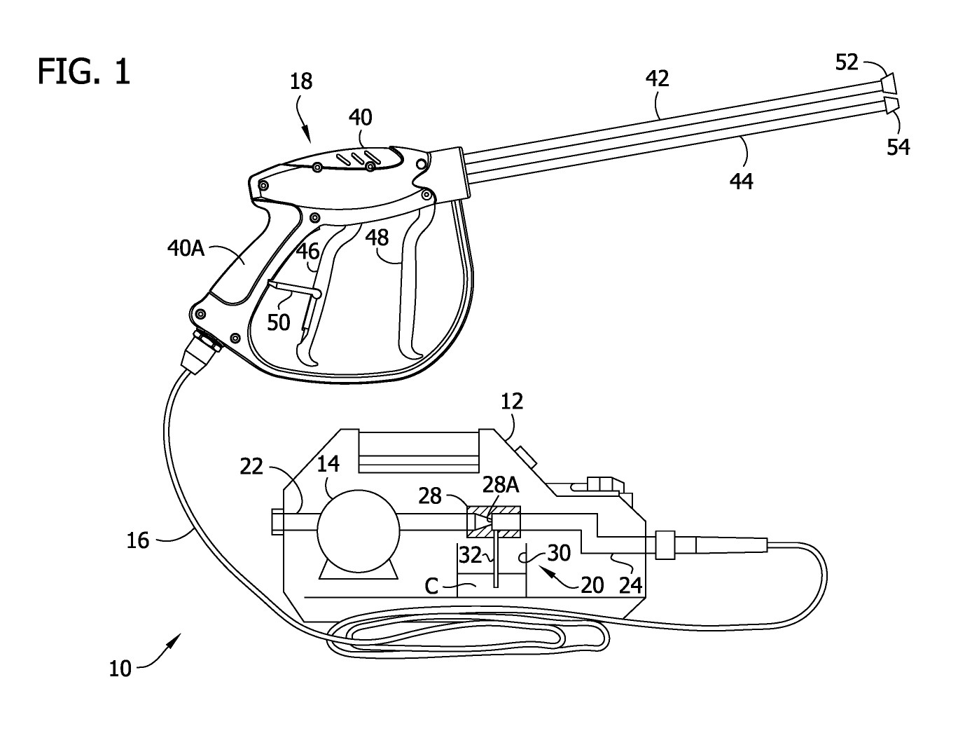

Referring to FIG. 1, one embodiment of a pressure washer is generally indicated at reference number 10. The pressure washer 10 includes a portable pressure unit 12 that includes a high pressure pump 14 (broadly, a pressurized water source). The pump 14 is configured to pump water from a water supply (not shown) through a hose 16 and further through a spray gun or wand (broadly, a sprayer), generally indicated at 18, to dispense a high pressure stream of water from the wand. While the pressure washer 10 is typically used to dispense a high pressure stream of water or a mixture of water mixed and another component, it will be understood that the pressure washer could be used for dispensing other liquids in certain embodiments. The illustrated pressure unit 12 includes a chemical injector, generally indicated at 20, which is configured to inject a liquid chemical C into the water downstream of the pump 14. For example, in one or more embodiments, the injector 20 can be configured to inject a surfactant such as a soap into the pressurized water so that the pressure washer 10 dispenses a high pressure mixture of water and surfactant suitable for cleaning a surface. The injector 20 may be located outside of the pressure unit 12 within the scope of the present invention. As will be explained in further detail below, the wand 18 is configured so that the injector 20 selectively injects the chemical C into pressurized water without the need for a removable chemical nozzle.

In the illustrated embodiment, the pressure unit 12 comprises a housing that substantially encloses the pump 14. In other embodiments the pressure unit could be an open frame or have another configuration. In certain embodiments, the pressure unit is mounted on wheels or casters for transporting the sprayer 10.

The pump 14 can have any configuration that is suitable for delivering a high pressure liquid through the pressure washer 10. In certain embodiments, the pump 14 is an electric pump. An electric pump 14 can be connected to an onboard power supply (not shown; e.g., a battery) or an external power source. In other embodiments, the pump 14 can be powered by an engine (not shown; e.g., a gasoline or natural gas engine) that is configured to drive the pump. An upstream conduit 22 fluidly connects the pump 14 to the water supply. For example, the upstream conduit 22 can include a threaded hose fitting for connecting the sprayer 10 to a water supply hose. A downstream conduit 24 extends between the pump 14 and the pressure washer hose 16 for conveying water from the pump to the hose. As explained below, the injector 20 is positioned along the flow path of the pressure washer 10 in the downstream conduit 22.

The illustrated injector 20 includes a venturi valve 28 positioned in the downstream conduit 24. The venturi valve 28 defines a flow restriction 28A. The cross-sectional flow area of the valve 28 is smaller at the flow restriction 28A than at a location upstream of the flow restriction. When water flows through the valve 28, the flow restriction 28A creates a pressure drop in the passage of the valve 28 at a location immediately downstream of the flow restriction. A container 30 having an interior adapted for holding the liquid chemical C is fluidly connected to the valve 28 just downstream of the flow restriction. More specifically, a tube 32 has a lower end positioned adjacent a bottom of the interior of the container 30 and an upper end connected to the venturi valve 28A immediately downstream of the flow restriction 28A. When water flows through the valve 28 at a sufficiently high flow rate, the negative pressure downstream of the flow restriction 28A draws the chemical C through the tube 32 into valve. The chemical C mixes with the water, and the mixture is delivered through the downstream conduit 24 into the hose 16. When the water flows through the valve 28 at a relatively low flow rate, the negative pressure is not strong enough to draw the chemical C into the valve through the tube 32 and thus the pressure washer 10 dispenses only water through the downstream conduit 24.

The pressurized liquid, whether pure water or a mixture of water and the chemical C, is pumped from the outlet of the downstream conduit 24 through the hose 16 and the wand 18, which dispenses a high pressure stream of the liquid as described further below. The hose 16 has an outlet in fluid communication with the wand 18 and an inlet opposite the outlet that connects the hose to the downstream conduit 24. Any suitable hose for channeling the high pressure liquid from the pump 14 to the wand 18 can be used without departing from the scope of the invention.

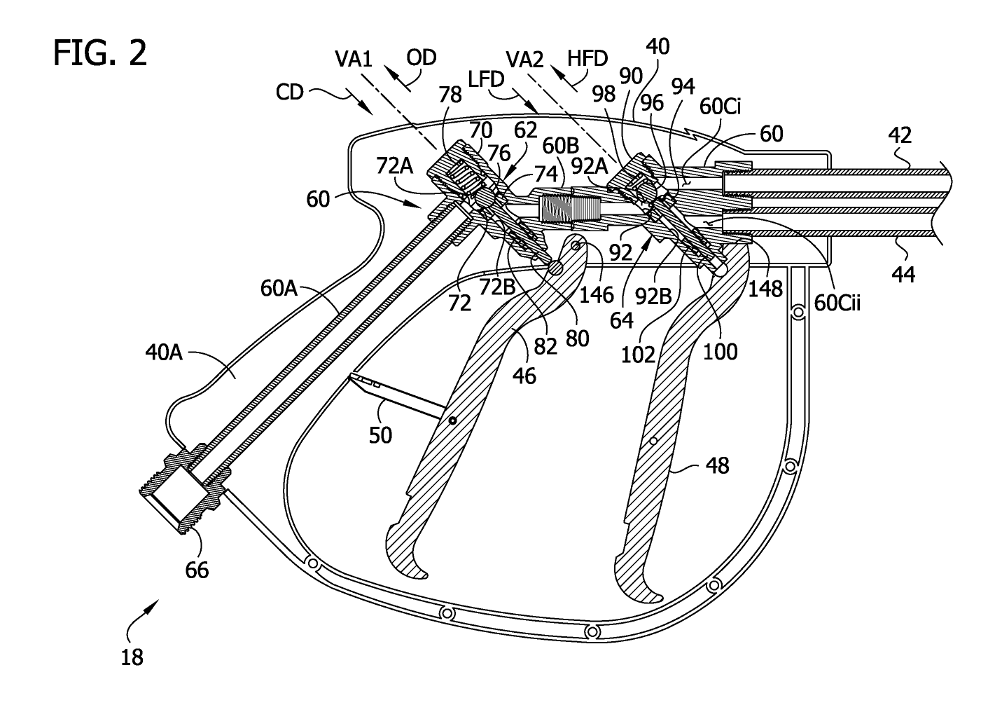

The wand 18 includes a housing 40 and first and second conduits 42, 44 extending from the housing. In the illustrated embodiment, the housing 40 has a rear pistol-grip portion 40A. Other housings can have other shapes in other embodiments. As explained in greater detail below, an actuation mechanism, which comprises first and second trigger levers 46, 48 pivotably mounted on the housing 40, is configured to selectively couple the hose 16 to the first and second conduits 42, 44 to selectively dispense the liquid from the first or second conduit. As shown in FIG. 2, each trigger lever 46, 48 is pivotably mounted on the housing 40 by a respective pin 146, 148 for pivoting movement about an axis of the respective pin. From an initial position, each trigger 46, 48 is pivotable about the axis of the respective pin 146, 148 in a direction toward the rear pistol-grip portion 40A of the housing 40 to activate the sprayer as explained below. In the illustrated embodiment, a stop lever 50 is pivotably mounted on the first trigger lever 46 to be selectively moveable between a stopping position (shown in FIG. 1) in which the stop lever engages the rear pistol-grip portion 40A of the housing 40 to prevent the trigger lever from pivoting away from the initial position and a released position in which the stop lever is aligned with the first trigger lever so that the trigger lever is selectively pivotable toward a rear portion of the housing to actuate the pressure washer 10.

Referring again to FIG. 1, the first conduit 42 is a high pressure conduit and the second conduit 44 is a high flow conduit. The first conduit 42 includes a high pressure nozzle 52 (e.g., a nozzle with a relatively small orifice) at an outlet end thereof and the second conduit 44 includes a high flow nozzle 54 (e.g., a nozzle with a relatively large orifice) at an outlet end thereof. The high flow conduit 44 has a lower resistance to fluid flow than the high pressure conduit 42. In one or more embodiments, the high pressure nozzle 52 is removably mounted (e.g., by a quick connect fitting) on the first conduit and replaceable with any of a plurality of high pressure nozzles (additional high pressure nozzles not shown). In other embodiments, the high pressure nozzle 52 is permanently mounted on the first conduit 42 to prevent misplacement of the nozzle. Suitably, the high flow nozzle 54 is permanently mounted on the second conduit 44 to prevent misplacement of the nozzle. It is understood that “permanently mounted,” as used herein, means only that the nozzle is not removed from the conduit in the course of normal use of the pressure washer; a nozzle can be “permanently mounted” on a conduit yet be removable for purposes of repair or maintenance. In certain embodiments, one or both of the nozzles 48, 50 can be adjustable to adjust a size and/or shape of the respective flow orifice.

Referring to FIG. 2, a bifurcated housing passage, generally indicated at 60, extends through the wand housing 40 to fluidly communicate between the high pressure hose 16 and the first and second conduits 42, 44. The housing passage 60 includes, an upstream portion 60A, a middle portion 60B, a downstream portion 60C, and first and second valves, generally indicated at 62, 64. The upstream portion 60A extends from an inlet fitting 66, which is configured for connecting the wand 18 to the hose 16, to the first valve 62. The middle portion 60B extends between the first and second valves 62, 64. And the downstream portion 60C extends from the second valve to the high pressure and high flow conduits 42, 44. The downstream portion 60C of the passage 60 includes first and second lumens 60Ci, 60Cii for communicating separately between the second valve 64 and the first and second conduits 42, 44, respectively.

The first valve 62 is mounted along the housing passage 60 between the upstream portion 60A and the middle portion 60B. The first valve 62 includes a valve body 70 that defines a valve passage 72 extending along a first valve axis VA1. A resiliently conformable valve seat 74 is positioned in the valve passage 72 between an upstream portion 72A and a downstream portion 72B. The upstream portion 60A of the housing passage 60 communicates with the upstream portion 72A of the valve passage 72, and the middle portion 60B of the housing passage communicates with the downstream portion 72B of the valve passage.

A closing element 76, which in the illustrated embodiment has a spherical shape, is received in the valve passage 72 for movement along the valve axis VA1 between a closed position and an open position. In the closed position, the closing element 76 sealingly engages the seat 74, thereby blocking fluid flow from the upstream portion 72A to the downstream portion 72B of the valve passage 72. Thus in the closed position, the first valve 62 interrupts fluid communication between the upstream portion 60A of the housing passage 60 and the middle portion 60B. In the open position, the closing element 76 is spaced apart from the valve seat 74 along the valve axis VA1 in the opening direction OD to allow fluid communication through the valve seat between the upstream and downstream portions 72A, 72B of the valve passage. Thus in the open position, the first valve 62 fluidly communicates between the upstream portion 60A of the housing passage 60 and the middle portion 60B.

In the illustrated embodiment, the first valve 62 is biased toward the closed position and movable to the open position using the first trigger lever 46. More specifically, a spring 78 extends between the closing element 76 and an end of the valve body 70 to impart a biasing force on the closing element in a closing direction CD. A valve stem 80 is connected to the closing element 76. The valve stem 80 extends from the closing element 76 through an opening in the valve body 70 to a free end positioned and arranged for engagement with the first trigger lever 46. The valve stem 80 is received in a packing element 82 for sliding movement along the valve axis VA1 with respect to the valve body 70. The packing element 82 is positioned in the valve passage 72 for forming a seal between the valve body 70 and the valve stem 80 at the opening through which the stem extends out of the valve body. A top portion of the trigger lever 46 is configured to operatively engage the free end of the valve stem 80. When the trigger lever 46 is pivoted about the axis of the pin 146 toward the rear portion 40A of the housing 40, the top portion of the trigger lever imparts an opening force on the free end of the valve stem 80. The valve stem and the closing element 76 move conjointly through the valve passage 72 along the valve axis VA1 in the opening direction OD against the biasing force of the spring 78 to position the first valve 62 in the open position. When the trigger lever 46 is released, the force of the spring 78 moves the closing element 76 and the valve stem 80 in the closing direction CD to the closed position.

The second valve 64 is mounted along the housing passage 60 between the middle portion 60B and the downstream portion 60C. The second valve 64 includes a valve body 90 that defines a valve passage 92 extending along a second valve axis VA2. A resiliently conformable valve seat 94 is positioned in the valve passage 92 between an upstream portion 92A and a downstream portion 92B. The middle portion 60B of the housing passage 60 and the first lumen 60Ci of the downstream portion 60C communicate with the upstream portion 92A of the valve passage 92, and the second lumen 60Cii of the downstream portion of the housing passage communicates with the downstream portion 92B of the valve passage.

A closing element 96, which in the illustrated embodiment has a spherical shape, is received in the valve passage 92 for movement along the valve axis VA2 between a low flow position and a high flow position. In the low flow position, the closing element 96 sealingly engages the seat 94, thereby blocking flow from the upstream portion 92A to the and downstream portion 92B of the valve passage 92. Thus in the low flow position, the second valve 64 fluidly communicates between the middle portion 60B of the housing passage 60 and the first lumen 60Ci of the downstream portion 60C and interrupts fluid communication between the middle portion of the housing passage and the second lumen 60Cii. In the high flow position, the closing element 96 is spaced apart from the valve seat 94 along the valve axis VA2 in the high flow direction HFD to allow fluid communication through the valve seat between the upstream and downstream portions 92A, 92B of the valve passage 92. Thus in the high flow position, the second valve 64 fluidly communicates between the middle portion 60B of the housing passage 60 and both the first lumen 60Ci and the second lumen 60Cii of the downstream portion 60C. But as explained below, because the high flow conduit 44 has lower resistance to fluid flow than the high pressure conduit 46, fluid is only dispensed from the wand 18 through the high flow nozzle 54 of the high flow conduit. It is contemplated that in other embodiments, in the high flow position, the second valve could be configured to block fluid flow from the middle portion of the housing passage to the first lumen of the downstream portion (and thus the high pressure conduit) to ensure that fluid flow through the high pressure conduit and nozzle is prevented when the second valve is in the high flow position.

In the illustrated embodiment, the second valve 64 is biased toward the low flow position and movable to the high flow position using the second trigger lever 48. More specifically, a spring 98 extends between the closing element 96 and an end of the valve body 90 to impart a biasing force on the closing element in a low flow direction LFD. A valve stem 100 is connected to the closing element 96. The valve stem 100 extends from the closing element through an opening in the valve body 90 to a free end positioned and arranged for engagement with the second trigger lever 48. The valve stem 100 is received in a packing element 102 positioned in the valve passage 92 for sliding movement with respect to the valve body 90 along the valve axis VA2. The packing element 92 is configured to form a seal between the valve body 90 and the valve stem 100 at the opening where the stem extends out of the valve body. A top portion of the trigger lever 48 is configured to operatively engage the free end of the valve stem 100. When the trigger lever 48 is pivoted about the axis of the pin 148 toward the pistol-grip portion 40A of the housing 40, the top portion of the trigger lever imparts an opening force on the free end of the valve stem 100 generally in the high flow direction HFD. The valve stem 100 and the closing element 96 move conjointly through the valve passage 72 along the valve axis A2 in the high flow direction HFD against the biasing force of the spring 98 to position the valve 64 in the high flow position. When the trigger lever 48 is released, the force of the spring 98 moves the closing element 106 and the valve stem 100 in the low flow direction LFD to the low flow position.

Referring to FIGS. 1 and 2, in an exemplary method of using the pressure washer 10, a water supply hose (not shown) is connected to the pressure supply unit 12 and the container 60 of the injector 20 is filled with a liquid surfactant C. Water flows through the upstream conduit 22 to the pump 14. When the pump 14 is activated, it pumps water from a water supply through the downstream conduit 24 and hose 16 and into the upstream portion 60A of the housing passage 60 of the wand 18. Before the trigger levers 46, 48 are pivoted toward the pistol grip portion 40A of the housing 40 to actuate the pressure washer 10, the first valve 62 is in the closed position and blocks water from flowing into the middle portion 60B of the housing passage 60.

A user holding the wand 18 can select between a high pressure stream of only water and a lower pressure stream of a water-surfactant mixture by depressing one or both of the trigger levers 46, 48. If a high pressure water stream is desired, the user depresses only the first trigger lever 46. As the first trigger lever 46 pivots about the axis of the pin 146 toward the rear portion 40A of the housing 40, it pushes the first valve stem 80 and the closing member 76 from the closed position in the opening direction OD to open the first valve 62. In the open position, the first valve 62 provides fluid communication between the upstream and middle portions 60A, 60B of the housing passage 60. With the spring 98 holding the second valve 64 in the low flow position, the second valve provides fluid communication between the middle portion 60B of the housing passage 60 and only the first lumen 60Ci of the downstream portion 60C. Thus, the pump 14 pumps the water through the housing passage 60 into the high pressure conduit 42 and not the high flow conduit 44. In order to generate a high output pressure, the high pressure nozzle 52 limits the flow rate of the water through the high pressure conduit 42 such that the flow restriction 28A of the venturi valve fails to generate enough negative pressure to draw the surfactant C into the flow passage 24. Thus, when only the first trigger lever 46 is depressed, the pressure washer 10 directs a high pressure stream of only water through the high pressure conduit 42.

If a water-surfactant mixture stream is desired, the user depresses both the first trigger lever 46 and the second trigger lever 48 simultaneously. As the second trigger lever 48 pivots about the axis of the pin 148 toward the pistol-grip portion 40A of the housing 40, it pushes the second valve stem 1000 and the closing member 96 of the second valve 64 from the low flow position in the high flow direction HFD to the high flow position. In the high flow position, the second valve 64 provides fluid communication between the middle portion 60B of the housing passage 60 and both lumens 60Ci, 60Cii of the downstream portion 60C. With the first trigger lever 46 also holding the first valve 62 in the open position, the pump 14 pumps the liquid through the housing passage 60 into both the high pressure conduit 42 and the high flow conduit 44. Because the high flow conduit 44 has a lower resistance to fluid flow than the high pressure conduit 42, the liquid is discharged from the high flow nozzle 54 and not the high pressure nozzle 52. Moreover, the high flow conduit 52 allows passage of the liquid stream at a flow rate sufficient for the venturi valve 28 to generate a pressure drop that draws the surfactant C into the downstream conduit 24. Thus, when both trigger levers 46, 48 are depressed, the surfactant C mixes with the water as the water flows through the pressure washer 10 and the wand 18 directs a stream of water-surfactant mixture through the high flow conduit 44.

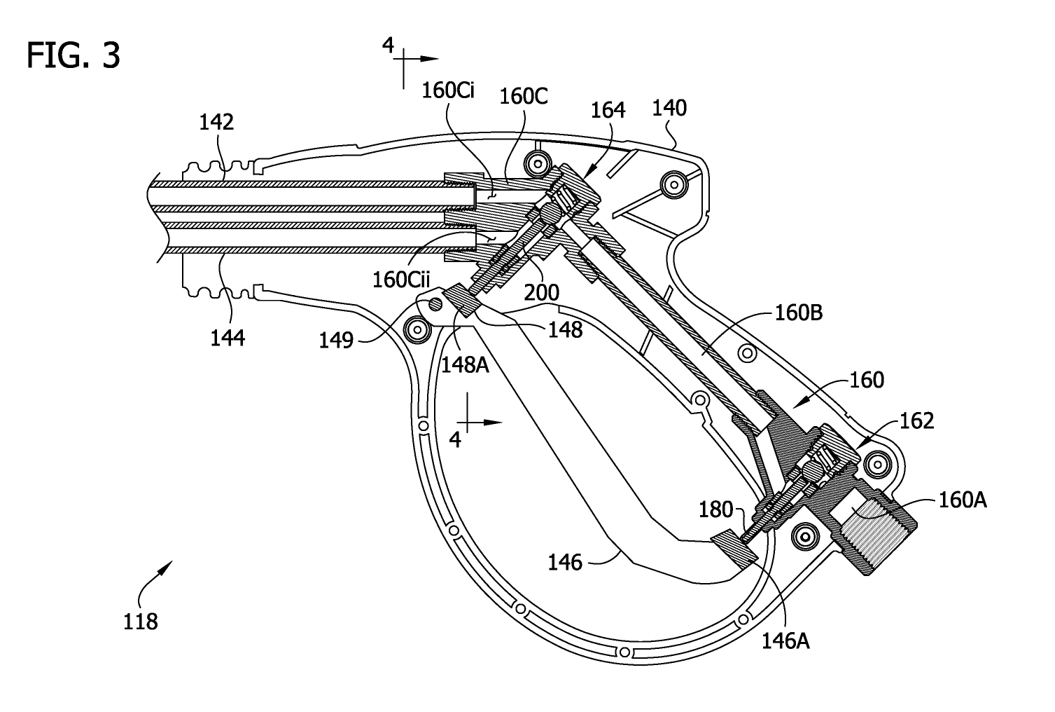

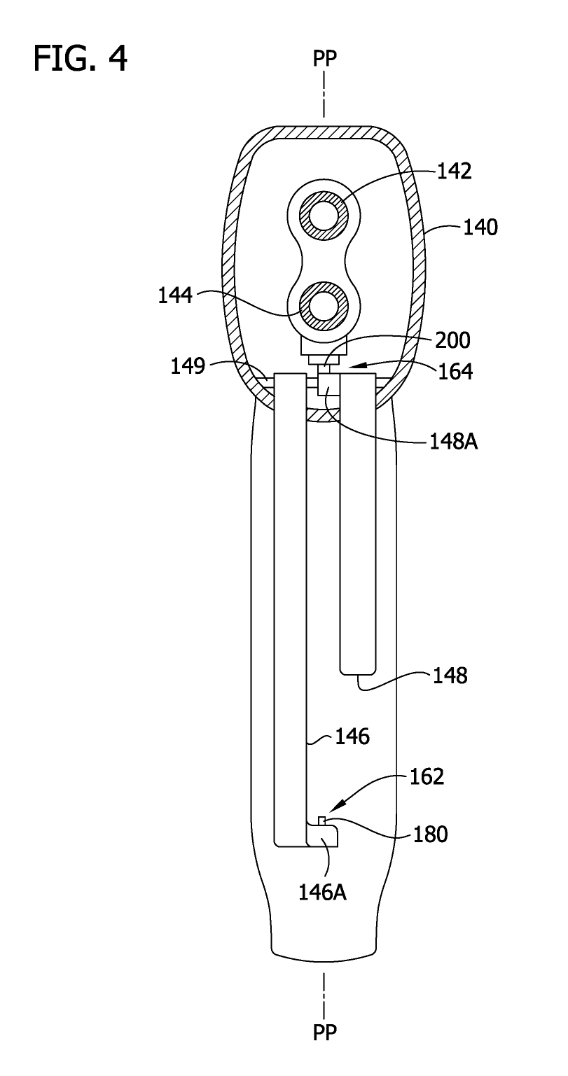

It is understood that the wand could have other configurations without departing from the scope of the invention. For example, referring to FIGS. 3 and 4, in one embodiment, a wand 118 includes first and second triggers 146, 148 that are arranged side-by-side on a wand housing 140. The wand 118 is similar in many respects to the wand 18 and corresponding parts are given corresponding reference numbers, plus 100. A housing passage 160 extends through the housing 140 and, as above includes, in order from downstream to upstream, an upstream portion 160A, a first valve 162, a middle portion 60B, a second valve 164, and a downstream portion 160C comprising first and second lumens 160Ci, 160Cii that are respectively connected to a high pressure conduit 42 and a high flow conduit 144. As above, the first valve 62 is biased toward a closed position in which the valve blocks fluid flow from the upstream portion 160A of the housing passage 160 to the middle portion 160B and movable to an open position in which the valve allows fluid communication between the upstream and middle portions. The second valve 164 is biased toward a low flow position in which the valve blocks fluid flow from the middle portion 160B to the second lumen 160Cii of the downstream portion and movable to a high flow position in which the valve permits fluid communication between the middle portion and both the first and second lumens 160Ci, 160Cii.

As shown in FIG. 4, the housing passage 160 is positioned generally in a passage plane PP of the wand 118 and first and second trigger levers 146, 148 are offset laterally on opposite sides of the middle plane. (The section of FIG. 3 is taken in the passage plane PP.) Each of the trigger levers 146, 148 is mounted on the wand housing 140 by a common pivot pin 149 for pivoting about the axis of the pivot pin. In the illustrated embodiment, the first trigger lever 46 extends downward from the pivot pin 149 a significantly greater distance than the second trigger lever 148. The first valve 162 is positioned near the bottom end of the wand housing 140 so that the bottom portion of the trigger lever 146 operatively engages the valve stem 180 and the second trigger lever 148 clears the valve stem. A user can press the bottom portion of the first trigger lever 146 without pressing the second trigger lever 148 to open the first valve 162 without actuating the second valve 164. The first trigger lever 146 includes an actuation element 146A adjacent the bottom end that projects laterally inward to intersect the passage plane PP. The actuation element 46A is shaped and arranged to operatively engage the valve stem 80 for selectively opening the first valve 162 when the first trigger lever 146 is depressed. Like the first trigger lever 146, the second trigger lever 148 includes an actuation element 148A that extends laterally inward to intersect the passage plane PP. In the illustrated embodiment, the actuation element 148A of the second trigger lever 148 is located adjacent the top end portion of the trigger lever, rearward of the pivot pin 149. The second valve 164 us spaced apart above the first valve 162, and the actuation element 148A of the second trigger lever 148 is positioned and arranged to operatively engage the valve stem 200. When the second trigger lever 148 is pivoted about the axis of the pin 149 toward the rear portion 140A of the housing 140, the actuation element 148A moves the valve stem 200 to position the second valve 164 in high flow position.

The side by side arrangement and relative sizes of the trigger levers 146, 148 ergonomically facilitate operating the wand 118 in either of two modes. In the first mode, the user positions the hand toward the bottom of the wand housing 140 so that no portion of the hand extends over the shorter second trigger lever 148. With the hand so positioned, the user squeezes the first trigger lever 146 to pivot the actuation element 146A about the axis of the pin 149 and thereby position the first valve 162 in the open position. Squeezing the first trigger lever 146 alone, therefore, actuates a first spray mode in which the wand 118 dispenses a high pressure stream of only water through the high pressure conduit 142. In the second mode, the user positions the hand toward the top portion of the housing 140 so that the hand extends over both trigger levers 146, 148. The user then simultaneously depresses both the first trigger lever 146 and the second trigger lever 148. The actuation elements 146A, 148A simultaneously move the valve stems 180, 200 to position the first valve 162 in the open position and position the second valve 164 in the high flow position, thus configuring the housing conduit 160 in a second mode for dispensing a water-chemical mixture at a high flow rate through the high flow conduit 144.

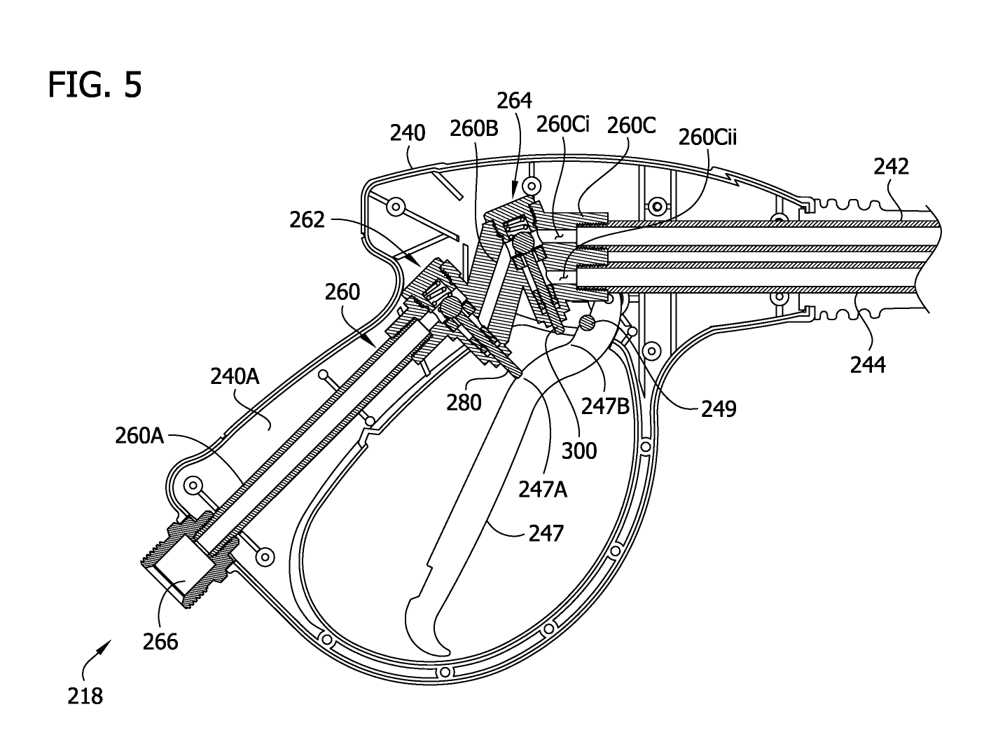

Referring to FIG. 5, another embodiment of a wand with a single sequential actuation mechanism is generally indicated at reference number 218. The wand 218 is similar in many respects to the wand 18, and like components are given like reference numbers, plus 200. The wand 218 includes a housing 240 and a passage 260 extending through the housing for conveying high pressure liquid from an inlet fitting 266 to a high pressure conduit 242 and a high flow conduit 244. Like the housing passage 60, the housing passage 260 includes, in upstream-to-downstream order, an upstream portion 260A, a first valve 262, a middle portion 260B, a second valve 264, and a downstream portion 260C comprising first and second lumens 260Ci, 260Cii that are respectively connected to the high pressure conduit 242 and the high flow conduit 244. As above, the first valve 262 is biased toward a closed position in which the valve blocks fluid from flowing from the upstream portion 260A of the housing passage 260 to the middle portion 260B and movable to an open position in which the valve allows fluid communication between the upstream and middle portions. The second valve 264 is biased toward a low flow position in which the valve blocks flow from the middle portion 260B to the second lumen 260Cii of the downstream portion 260C while allowing fluid flow from the middle portion to the first lumen 260Ci. The second valve 264 is movable to a high flow position in which the valve permits fluid communication between the middle portion 260B and both the first and second lumens 260Ci, 260Cii.

Unlike the wand 18, the wand 218 includes a single trigger lever 247 that is configured to pivot about a pin 249 to move the first valve 262 from the closed position toward the open position and to move the second valve 264 from the low flow position toward the high flow position. The top end portion of the trigger lever 247 includes a first valve engagement section 247A and a second valve engagement section 247B spaced apart between the first valve engagement section and the pin 249. In an initial position shown in FIG. 5, the first valve engagement section 247A engages the valve stem 280 positioned in the closed position of the valve 262 and the second valve engagement section 247B is spaced apart from the valve stem 300 positioned in the low flow position of the valve 264. The trigger lever 247 is configured to pivot about the axis of the pin 249 from the initial position toward the pistol grip portion 240A of the housing 240 through an angular range of motion including a first angular position and a second angular position closer to the rear portion 240A of the housing than the first angular position. At the first angular position, the first valve engagement section 247A of the trigger lever 247 moves the valve stem 280 to the open position of the first valve and the valve stem 300 of the second valve 264 remains in the high flow position. Thus, the housing passage 260 fluidly couples the inlet fitting 266 to the high pressure conduit 242 but blocks liquid flow to the high flow conduit 244. As the trigger lever 247 pivots from the first angular position toward the second angular position, the second valve engagement section 247B engages the valve stem 300. In the second angular position, the second valve engagement section 247B moves the valve stem 300 to the high flow position to fluidly couple the inlet fitting 266 to the high flow conduit 244. Thus, in the second angular position of the trigger 247, the wand 218 directs a liquid through the high flow conduit at a high flow rate operative to inject liquid chemical C into water flowing through a pressure washer 10 as described above.

As can be seen therefore, the pressure washer wands 18, 118, 218 provide a mechanism for selecting between operating a pressure washer in a high pressure mode and a high flow mode suitable for chemical injection without removing and replacing nozzles. Because the high flow nozzle can be permanently mounted on the high flow conduit, the likelihood of misplacing the high flow nozzle—and thereby rendering the chemical injector of the pressure washer inoperable—is greatly diminished.

Having described the invention in detail, it will be apparent that modifications and variations are possible without departing from the scope of the invention defined in the appended claims.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

1. A sprayer for dispensing liquid, said sprayer comprising:
a housing having a passage therethrough, said passage having one upstream portion, one middle portion, and a plurality of downstream portions including a first downstream portion and a second downstream portion;
a first conduit connected to the first downstream portion;
a second conduit connected to the second downstream portion, said second conduit having lower resistance to fluid flow than said first conduit;
a first valve mounted along the housing passage between the upstream portion and the middle portion, said first valve being selectively moveable between a closed position, in which the first valve blocks fluid flow through the housing passage, and an open position, in which the first valve allows fluid flow through the housing passage from the upstream portion to the middle portion; and
a second valve mounted along the housing passage downstream from the first valve and between the middle portion and the downstream portions, said second valve being selectively moveable between a low flow position, in which the second valve allows fluid flow through the housing passage from the middle portion to the first downstream portion of the passage, and a high flow position, in which the second valve allows fluid flow through the housing passage from the middle portion to the second downstream portion of the passage;
wherein the first and second conduits comprise at least one elongate tube that protrudes longitudinally from the housing.

2. A sprayer as set forth in claim 1, wherein the second valve allows fluid through the housing passage from the middle portion to both the first downstream portion of the passage and the second downstream portion of the passage when in the high flow position.

3. A sprayer as set forth in claim 1, wherein the first valve is biased toward the closed position.

4. A sprayer as set forth in claim 3, further comprising a lever pivotally attached to the housing and selectively pivotable relative to the housing to move the first valve toward the open position.

5. A sprayer as set forth in claim 4, wherein the lever includes a stop selectively moveable between a stopping position, in which the stop prevents the lever from pivoting, and a released position in which the lever is selectively pivotable relative to the housing to move the first valve toward the open position and the second valve toward the high flow position.

6. A sprayer as set forth in claim 5, wherein said lever is a first lever and the sprayer further comprises a second lever pivotally attached to the housing and selectively pivotable relative to the housing to move the second valve toward the open position and the second valve toward the high flow position.

7. A sprayer as set forth in claim 3, wherein the first valve includes a spring that biases the valve toward the closed position.

8. A sprayer as set forth in claim 3, wherein the second valve is biased toward the low flow position.

9. A sprayer as set forth in claim 8, wherein the second valve includes a spring that biases the valve toward the low flow position.

10. A sprayer as set forth in claim 1, further comprising a lever pivotally attached to the housing and selectively pivotable relative to the housing to move the first valve toward the open position and the second valve toward the high flow position.

11. A sprayer as set forth in claim 10, wherein the lever moves the first valve toward the open position when the lever is pivoted through a first angular position and the lever moves the second valve toward the high flow position when the lever is pivoted through a second angular position spaced apart from the first angular position.

12. A sprayer as set forth in claim 1, wherein the second valve is biased toward the low flow position.

13. A sprayer as set forth in claim 12, further comprising a lever pivotally attached to the housing and selectively pivotable relative to the housing to move the second valve toward the high flow position.

14. A sprayer as set forth in claim 1, in combination with:
a hose having an outlet, to which the sprayer is connected, and an inlet opposite the outlet;
a pressurized water source in fluid communication with the inlet of the hose;
a venturi mounted in fluid communication with the hose between the pressurized water source and the hose inlet, said venturi having an entrance, an exit, and a narrow section between said entrance and said exit; and
a container having an interior adapted for holding liquid surfactant, said container having a tube having a lower end positioned adjacent a bottom of the interior of the container and an upper end connected to the narrow section of the venturi so that surfactant in the interior is drawn upward through the tube to enter water passing through the venturi when a pressure differential across the venturi exceeds a predetermined value.

15. A spray system for alternatively dispensing pressurized water and a mixture of pressurized water and surfactant, said system comprising:
a hose having an inlet and an outlet;
a pressurized water source in fluid communication with the inlet of the hose;
a venturi mounted in fluid communication with the hose between the pressurized water source and the hose inlet, said venturi having an entrance, an exit, and a narrow section between said entrance and said exit;
a container having an interior adapted for holding liquid surfactant, said container having a tube having a lower end positioned adjacent a bottom of the interior of the container and an upper end connected to the narrow section of the venturi so that surfactant in the interior is drawn upward through the tube to enter water passing through the venturi when a pressure differential across the venturi exceeds a predetermined value;
a sprayer connected to the hose outlet, the sprayer comprising:
a housing having a passage therethrough, said passage having one upstream portion, one middle portion, and a plurality of downstream portions including a first downstream portion and a second downstream portion;
a first conduit fluidly connected to the first downstream portion;
a second conduit fluidly connected to the second downstream portion, said second conduit having lower resistance to fluid flow than said first pressure conduit;
a first valve mounted along the housing passage between the upstream portion and the middle portion, said first valve being selectively moveable between a closed position, in which the first valve blocks fluid flow through the housing passage, and an open position, in which the first valve allows fluid flow through the housing passage from the upstream portion to the middle portion; and
a second valve mounted along the housing passage downstream from the first valve and between the middle portion and the downstream portions, said second valve being selectively moveable between a low flow position, in which the second valve allows fluid flow through the housing passage from the middle portion to the first downstream portion of the passage, and a high flow position, in which the second valve allows fluid flow through the housing passage from the middle portion to the second downstream portion of the passage.

16. A spray system as set forth in claim 15, wherein the second valve allows fluid through the housing passage from the middle portion to both the first downstream portion of the passage and the second downstream portion of the passage when in the high flow position.

17. A spray system as set forth in claim 15, further comprising a lever pivotally attached to the housing and selectively pivotable relative to the housing to move the first valve toward the open position

18. A spray system as set forth in claim 17, wherein said lever is a first lever and the sprayer further comprises a second lever pivotally attached to the housing and selectively pivotable relative to the housing to move the second valve toward the open position and the second valve toward the high flow position.

19. A spray system as set forth in claim 15, further comprising a lever pivotally attached to the housing and selectively pivotable relative to the housing to move the first valve toward the open position and the second valve toward the high flow position.

20. A spray system as set forth in claim 19, wherein the lever moves the first valve toward the open position when the lever is pivoted through a first predetermined angle and the lever moves the second valve toward the high flow position when the lever is pivoted through a second predetermined angle greater than the first predetermined angle.
